(19) United States
(12) Patent Application Publication
(10) Pub. No.: US 2014/0079511 A1
(43) Pub. Date: Mar. 20, 2014

(54) Mounting Fastener for Securing Loads to Surfaces

(71) Applicant: Worthington Maritime, LLC, Sweetwater, TN (US)

(72) Inventor: Anthony Saccenti, Miami, FL (US)

(73) Assignee: Worthington Maritime, LLC, Sweetwater, TN (US)

(21) Appl. No.: 14/027,763

(22) Filed: Sep. 16, 2013

Related U.S. Application Data
(60) Provisional application No. 61/701,076, filed on Sep. 14, 2012.

(51) Int. Cl. F16B 19/00

(52) U.S. Cl. CPC F16B 19/00
USPC 411/500

(57) ABSTRACT

A mounting fastener comprises a piston having an extendable and retractable piston head. The piston head is mounted in a through bore defined by a first surface to allow slidable movement of the piston head in relation to the first surface along an axis of the through bore. A second surface is configured to overlie and mate with the first surface. The second surface defines a through opening disposed along the second surface such that the through opening is brought into registration with the through bore when the second surface is mated with said first surface. The through opening is sized to receive and engage the piston head. Thus, mating of the first and second surfaces and engagement of the piston head by the second surface secures the second surface against movement along the piston central axis and along the first surface.

### CROSS-REFERENCE TO RELATED APPLICATIONS

This application claims the benefit of U.S. Provisional Patent Application Ser. No. 61/701,076, filed on Sep. 14, 2012, incorporated herein in its entirety by reference.

### STATEMENT REGARDING FEDERALLY-SPONSORED RESEARCH OR DEVELOPMENT

Not Applicable

### BACKGROUND OF THE INVENTION

1. Field of Invention

The invention relates to fasteners, and more particularly, to a mounting fastener which is useful, for example, in mounting one or more items to a surface, such as for example to a deck of a marine vessel.

2. Description of the Related Art

The use of fasteners to secure a load to a surface is known in the art. For example, in the use of marine vessels, it is often desirable to place a load, such as for example a loaded container, pallet, rack, frame, heavy object or bundle of objects, or other such item (hereinafter “load”), on a deck of the marine vessel for transportation or for use by the marine vessel. It is often desirable that such loads be capable of being quickly placed on the deck, and if necessary, quickly removed therefrom. In several applications, it is further desirable to secure the load against movement away from or along the deck, for example to limit shifting or other movement of the load during operation of the marine vessel in a body of water.

Oscillating movement of the marine vessel deck in various directions, which is often created by waves encountered by the marine vessel as the marine vessel moves through water, often results in several challenges in securing loads along deck surfaces of a marine vessel. In order to secure loads against movement in all directions along the deck as well as away from the deck, large amounts of lashings, chains, netting, or other such devices are often used. However, such lashings and/or netting often restrict access to the load, such that quick access to and utilization of items comprising the load by the marine vessel is often limited. Traditional fasteners such as nut and bolt fasteners may be used, however, such traditional fasteners often limit the speed at which such loads may be placed on and secured to, or unsecured and removed from, the deck. Thus, there is a need in the art for a mounting fastener which is capable of quickly securing a load to a surface, and which allows for speedy release and removal of the load from the surface.

### BRIEF SUMMARY OF THE INVENTION

According to several features of the present general inventive concept, a mounting fastener may be provided which is useful in securing a load to a surface. In certain embodiments, the mounting fastener may comprise a piston having an extendable and retractable piston head, the piston head defining a T-shaped cross-section along a central axis of the piston head, and a first surface defining a through bore. Such piston may be, for example, a hydraulic piston. The piston head may be mounted within the through bore for slidable movement in relation to the first surface along an axis of the through bore. The mounting fastener may further comprise a second surface configured to overlie and mate with the first surface, the second surface defining a through opening disposed along the second surface such that the through opening is brought into registration with the through bore when the second surface is mated with the first surface, the through opening being sized to receive and engage the piston head. Thus, mating of the first and second surfaces and engagement of the piston head by the second surface may secure the second surface against movement along the piston central axis and along the first surface.

In certain embodiments, the first surface may have a contoured shape, and the second surface may conform to the first surface. For example, in certain embodiments, the mounting fastener may comprise a first member defining a tapered depression on a first surface thereof and a through bore at a central location along the first depression, the through bore opening to a second surface of the first member opposite the first surface. A piston may be provided having a piston head mounted within the through bore for slidable movement in relation to the first member along an axis of the through bore, and a second member may be provided defining a protrusion sized and shaped to mate with the tapered depression. The second member may further define a through opening sized to receive the piston head to allow engagement of the piston head by the second member. Thus, mating of the protrusion with the tapered depression and engagement of the piston head by the second member may secure the second member against movement along the through bore axis and along the first member first surface. In certain embodiments, the depression may have a substantially rectangular, tapered shape.

In certain embodiments, the piston head may be rotatable along a central axis thereof in relation to the first member between a first rotational position and a second rotational position. The piston head may further have a T-shaped cross-section along the piston head central axis. The first member may further define a second, oblong depression extending partially along an axial dimension of the through bore. The oblong depression may cooperate with a portion of the through bore to define a cavity keyed to the piston head. Thus, the piston head may be receivable within the cavity at a first rotational position of the piston head.

The through opening of the second member may, in certain embodiments, have an oblong shape corresponding to the oblong depression. Thus, the through opening may be positioned to align with the oblong depression in the first member along an axial dimension of the through bore when the protrusion is mated with the tapered depression. In some embodiments, the piston head may be retractable within the through bore at a first rotational position of the piston head. In some embodiments, the piston head may be extendable through the oblong depression and the through opening in the first rotatable position and rotatable to the second position. The piston head may be non-retractable through the through opening in the second rotatable position. In certain embodiments, the second member may define a first surface thereof opposite the protrusion. The second member first surface may define a blind bore extending from the second member first surface to the through opening. This blind bore may have a diameter greater than or equal to a long dimension of the through opening and the oblong depression, thus providing access to the piston head when the piston head is received into the blind bore.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view showing one embodiment of a mounting latch constructed in accordance with several features of the present general inventive concept;

FIG. 2 is a partial cutaway perspective view of the mounting latch of FIG. 1, showing the second member in engagement with the first member;

FIG. 3 is a partial cutaway perspective view of the mounting latch of FIG. 2, showing the piston head extended and in the first rotational position;

FIG. 4 is a partial cutaway perspective view of the mounting latch of FIG. 3, showing the piston head extended and in the second rotational position; and

FIG. 5 is a partially exploded perspective view of a platform incorporating one embodiment of a mounting latch constructed in accordance with several features of the present general inventive concept, together with a load to be secured along the platform.

### DETAILED DESCRIPTION OF THE INVENTION

A latch which is useful, for example, in securing a load to a surface, such as for example a cargo container or other load to a deck of a marine vessel, is disclosed herein and in the accompanying figures. The latch provides positive engagement between two fastener members which may be quickly and conveniently engaged to one another and/or quickly released therefrom.

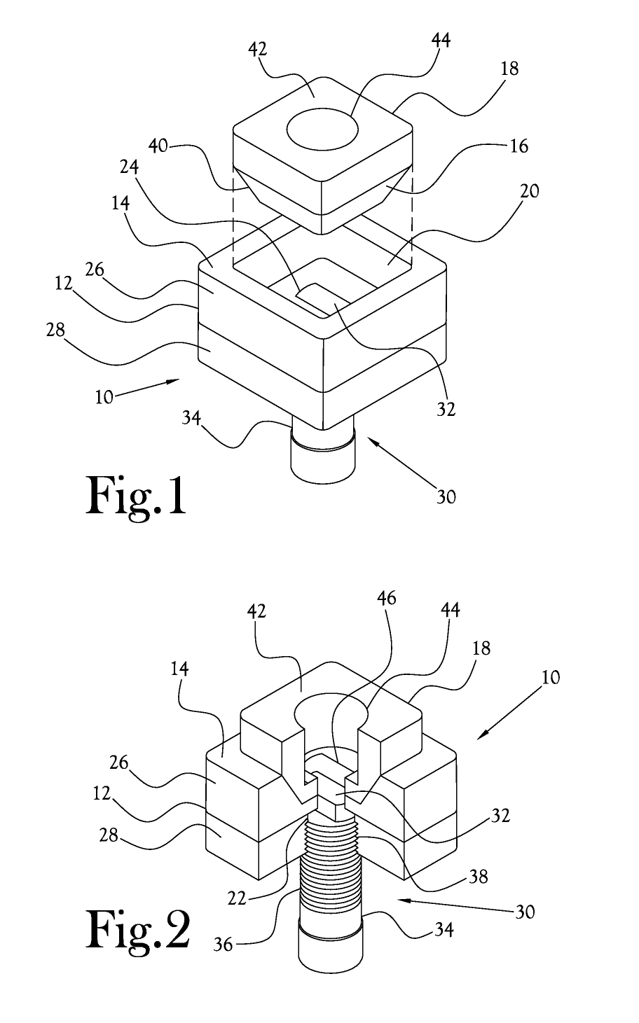

FIGS. 1 and 2 illustrate one embodiment of a fastener 10 suitable for use in securing a load to a platform. Referring to FIG. 1, in one embodiment, the fastener 10 includes a first member 12 defining a first surface 14 which is adapted to mate with and engage a first surface 16 of a second member 18 to establish a releasable connection thereto. The first member 12 is defined in the illustrated embodiment by a first block having an upper surface 14 defining a substantially rectangular and tapered depression 20. A through bore 22 is defined at a central location along the tapered depression 20 and opens to a lower surface of the first member 12. In the illustrated embodiment, an upper portion of the through bore 22 defines an oblong depression 24 having a depth extending partially along an axial dimension of the through bore 22. The oblong depression 24 has a long dimensional width extending along the surface of the tapered depression 20 defined by the first member 12. A central location of the tapered depression 20 is in registration with a central axis of the through bore 22. Thus, the oblong depression 24 cooperates with the through bore 22 to define a cavity having a generally T-shaped cross-section along an axial dimension of the through bore 22. In the illustrated embodiment, the first member 12 comprises an upper member 26, which generally defines the upper surface 14 of the first member 12 and the oblong depression 24, and a lower member 28, which defines the remainder of the through bore 22. The upper and lower members 26, 28 are arranged in an overlying, stacked configuration, such that the central location of the oblong depression 24 is brought into registration with the central axis of the through bore 22, and joined by means known to one of ordinary skill in the art. Other means for forming the first member 12 will be apparent to one of ordinary skill in the art.

A piston 30 is received within the through bore 22 and is configured for slidable movement generally along the central axis of the through bore 22. The piston 30 defines a head portion 32 having a T-shaped cross-section which is sized and shaped to fit within the cavity formed by the oblong depression 24 and the through bore 22, such that the piston head 32 is capable of extending from the through bore 22 into the region above the tapered depression 20 and retracting from above the tapered depression 20 and into the through bore 22 and the oblong depression 24. In the illustrated embodiment, the piston 30 defines a generally cylindrical housing 34 having an externally threaded surface 36. The externally threaded surface 36 of the housing 34 is sized to threadably mate with an internally threaded surface 38 of the lower member 28, such that the housing 34 may be fastened within the through bore 22. In this configuration, the piston head 32 extends generally upwardly through the through bore 22 and into the oblong depression 24 of the upper member 26.

As discussed above, the piston head 32 is configured to extend from the housing 34 into the region above the tapered depression 20 and retract from above the tapered depression 20 and into the through bore 22 and the oblong depression 24. In several embodiments, the piston 32 is a hydraulic piston, such that slidable movement of the piston head 32 is actuated through movement of fluid into an interior of the housing 34, thereby driving the piston head 32 outwardly from within the housing 34, and conversely, through movement of fluid from an interior of the housing 34, thereby drawing the piston head into the housing 34. However, it will be recognized that the piston 30 may be any of a number of piston types known in the art, such as for example a hydraulic or pneumatic piston, a spring-biased piston, etc., without departing from the spirit and scope of the present general inventive concept. In several embodiments, the piston 30 is biased toward retraction within the through bore 22 and the oblong depression 24, as by a spring bias, a hydraulic or pneumatic cylinder, or other such device. However, such bias is not necessary to accomplish the present general inventive concept.

In the illustrated embodiment, the second member 18 is defined by a second block having a lower surface 16 defining a substantially rectangular and tapered protrusion 40 which is generally shaped to conform to and mate with the tapered depression 20 of the first member 12. In the illustrated embodiment, a top surface 42 of the second member 18 defines a blind bore 44 extending generally downwardly toward the second block lower surface 16 and having a diameter greater than or equal to the long dimension of the oblong depression 24 of the first member 12 and corresponding T-shaped head portion 32 of the piston 30. An oblong through opening 46 is defined on a base surface of the blind bore 44 having dimensions approximately equal to the dimensions of the oblong depression 24 and opening to the lower surface 16 of the second member 18. The oblong through opening 46 is disposed along the second member 18 such that, when the protrusion 40 is received in mating engagement with the tapered depression 20, the oblong through opening 46 is brought into substantial registration with the oblong depression 24.

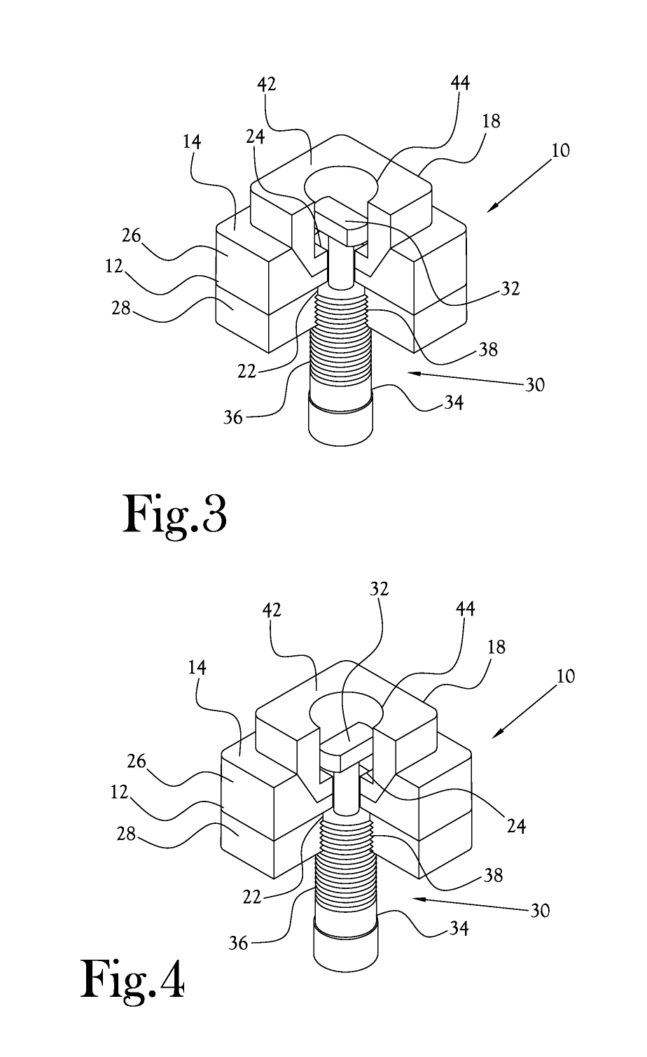

According to several features of the present general inventive concept, the piston head 32 is rotatable between a first position (FIGS. 2 and 3), in which the T-shaped piston head 32 is aligned to mate with the oblong depression 24 and the through opening 22, and a second position (FIG. 4), in which the T-shaped piston head 32 is out of alignment, such that the T-shaped piston head 32 is not able to mate with the oblong depression 24 and the through opening 22. Thus, as shown in FIG. 2, when the piston head 32 is positioned in the first position and retracted into the oblong depression 24 and through opening 20, the protrusion 40 of the second member 18 may be received within the tapered depression 20 of the first member 12, such that the oblong through opening 46 is brought into substantial registration with the oblong depression 24. In this configuration, as shown in FIG. 3, the piston head 32 may be extended along the central axis of the through bore 22 such that the piston head 32 extends through the oblong through opening 46 and into the blind bore 44. Referring to FIG. 4, the piston head 32 may then be turned about the long dimension of the piston head 32 to the second position (approximately 90 degrees in the illustrated embodiment), such that the T-shape of the piston head 32 no longer aligns with the oblong through opening 46 and oblong depression 24, and therefore cannot be slidably withdrawn from the blind bore 46 along the axis of the piston 30. In this manner, the piston head 32 serves to lock the first and second members 12, 18 in mating engagement with one another. Conversely, by rotating the piston head 32 to the first position (FIG. 3), the piston head 32 may be retracted into the oblong depression 24 and through bore 22 of the first member 12, thereby allowing the second member 18 to be disengaged from the first member 12.

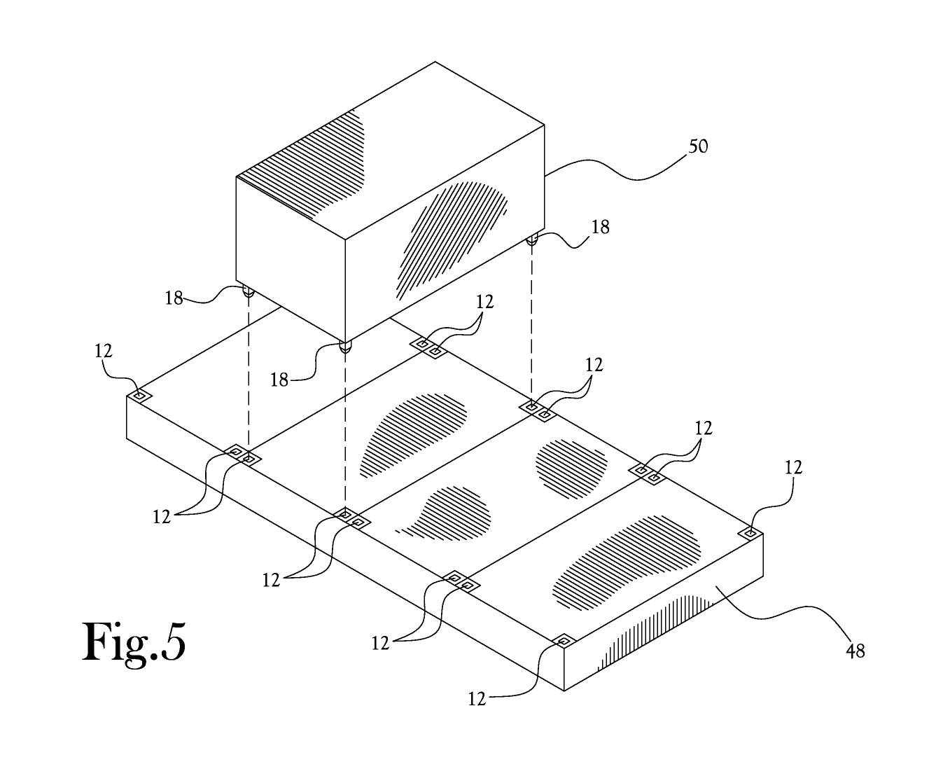

Referring to FIG. 5, in several embodiments, a plurality of first fastener members 12 are provided at selected locations along a platform 48. It will be recognized that the platform 48 may form a portion of any surface to which it is desirable to attach a load 50, such as for example the deck of a marine vessel. An equal number of second fastener members 18 are provided at selected locations along an underside of a load 50, such that each fastener member 18 of the load 50 aligns with and mates with a first fastener member 12 of the platform 48 when the load 50 is placed at a desired location on the platform 48. Upon placement of the load 50 on the platform 48 with each first fastener member 12 in mating engagement with a corresponding second fastener member 18, each piston 30 of each first fastener member 12 may be actuated and rotated to the second position, as described above, to lock each second fastener member 18 in mating engagement with a corresponding first fastener member 12. In this manner, at least a portion of the various first and second fastener members 12, 18 may cooperate to releasably secure the load 50 in place on the platform 48, and to at least discourage, and preferably prevent, movement of the load 50 in relation to the platform 48. In several embodiments, each fastener 10 is in operative communication with suitable controls (not shown), which are provided to allow selective locking and/or unlocking of the fasteners 10 from a location remote from the load 50 and platform 48, such as for example from within a wheelhouse or other operative location of a marine vessel, or from another remote location.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A mounting fastener useful in securing a load to a surface, said mounting fastener comprising:
a first member defining a tapered depression on a first surface thereof and a through bore at a central location along said first depression, said through bore opening to a second surface of said first member opposite said first surface;
a piston having a piston head mounted within said through bore for slidable movement in relation to said first member along an axis of said through bore; and
a second member defining a protrusion sized and shaped to mate with said tapered depression, said second member further defining a through opening sized to receive said piston head to allow engagement of said piston head by said second member;
whereby mating of said protrusion with said tapered depression and engagement of said piston head by said second member secures said second member against movement along said through bore axis and along said first member first surface.

2. The mounting fastener of claim 1, said depression having a substantially rectangular, tapered shape.

3. The mounting fastener of claim 1, said piston head being rotatable along a central axis thereof in relation to said first member between a first rotational position and a second rotational position.

4. The mounting fastener of claim 3, said piston head having a T-shaped cross-section along said piston head central axis.

5. The mounting fastener of claim 4, said first member further defining a second, oblong depression extending partially along an axial dimension of said through bore, said oblong depression cooperating with a portion of said through bore to define a cavity keyed to said piston head, whereby said piston head is receivable within said cavity at a first rotational position of said piston head.

6. The mounting fastener of claim 5, said through opening having an oblong shape corresponding to said oblong depression, said through opening being positioned to align with said oblong depression along an axial dimension of said through bore when said protrusion is mated with said tapered depression.

7. The mounting fastener of claim 6, wherein said piston head is extendable through said oblong depression and said through opening in said first rotatable position and not retractable through said through opening in said second rotatable position.

8. The mounting fastener of claim 7, said second member having a first surface thereof opposite said protrusion, said second member first surface defining a blind bore extending from said second member first surface to said through opening.

9. The mounting fastener of claim 8, said blind bore having a diameter greater than or equal to a long dimension of said through opening and said oblong depression.

10. The mounting fastener of claim 9, said piston being a hydraulic piston.

11. A mounting fastener useful in securing a load to a surface, said mounting fastener comprising:
a piston having an extendable and retractable piston head, said piston head defining a T-shaped cross-section along a central axis of said piston head;
a first surface defining a through bore, said piston head mounted within said through bore for slidable movement in relation to said first surface along an axis of said through bore; and
a second surface configured to overlie and mate with said first surface, said second surface defining a through opening disposed along said second surface such that said through opening is brought into registration with said through bore when said second surface is mated with said first surface, said through opening being sized to receive and engage said piston head;
whereby mating of said first and second surfaces and engagement of said piston head by said second surface secures said second surface against movement along said piston central axis and along said first surface.

12. The mounting fastener of claim 11, said first surface having a contoured shape, said second surface conforming to said first surface.

13. The mounting fastener of claim 11, said piston head being rotatable along said central axis thereof in relation to said first surface between a first rotational position and a second rotational position.

14. The mounting fastener of claim 13, said piston head being retractable within said through bore at a first rotational position of said piston head.

15. The mounting fastener of claim 14, said first surface further defining an oblong depression extending partially along an axial dimension of said through bore, said oblong depression cooperating with a portion of said through bore to define a cavity keyed to said piston head, whereby said piston head is receivable within said cavity at a first rotational position of said piston head.

16. The mounting fastener of claim 15, said through opening having an oblong shape corresponding to said oblong depression, said through opening being positioned to register with said oblong depression when said first and second surfaces are mated.

17. The mounting fastener of claim 16, wherein said piston head is extendable through said oblong depression and said through opening in said first rotatable position and not retractable through said through opening in said second rotatable position.

18. The mounting fastener of claim 17, said piston being a hydraulic piston.
